(19) United States
(12) Patent Application Publication
(10) Pub. No.: US 2011/0244167 A1
(43) Pub. Date: Oct. 6, 2011

(54) Thermal insulation core material and vacuum insulation panel and manufacturing process thereof

(75) Inventors: Mao Guo, Chongqing (CN); Dajiang Qin, Chongqing (CN)

(73) Assignee: CHONGQING ZAISHENG TECHNOLOGY DEVELOPMENT CO.,LTD, Chongqing (CN)

(21) Appl. No.: 12/947,515

(22) Filed: Nov. 16, 2010

(30) Foreign Application Priority Data
Apr. 6, 2010 (CN) 201010139691.5
Apr. 6, 2010 (CN) 201010139702.X

(51) Int. Cl. B32B 5/02; B32B 37/00; D21H 13/40

(52) U.S. Cl. 428/69; 156/286; 162/156

(57) ABSTRACT

A thermal insulation core material and a vacuum insulation panel and a manufacturing process thereof are disclosed. The process for manufacturing a thermal insulation core material comprises: A) stirring and dispersing a mixture of glass fiber cotton and water to obtain a slurry; B) adding water and dilute sulfuric acid into the slurry to obtain a concentration of 0.1% and a pH value in a range of 2.5-3.0; C) removing residue from the slurry to obtain a qualified slurry, the residue comprising unmelted glass fibers; D) transporting the qualified slurry from a high-level tank to a head box, through which the qualified slurry flows onto a forming mesh where the qualified slurry is dehydrated to obtain a plate-shaped core material; E) transporting the plate-shaped core material into a vacuum box for compression and dehydration; and F) drying the plate-shaped core material.

### CROSS-REFERENCE TO RELATED APPLICATIONS

This application claims the benefit of foreign priority to China Application No. 201010139691.5, filed on Apr. 6, 2010; and to China Application No. 201010139702.x, filed on Apr. 6, 2010.

### TECHNICAL FIELD OF THE INVENTION

The present invention relates to the field of heat preservation material, and in particular to a thermal insulation core material and a vacuum insulation panel and a manufacturing process thereof.

### BACKGROUND OF THE INVENTION

Just as the name implies, a vacuum insulation panel is based on the principle of vacuum thermal insulation, which insulates heat conduction by improving the vacuum degree in the panel and filling a thermal insulation core material into the panel to, so as to achieve the purpose of heat preservation and saving energy.

The thermal insulation core material is an important part in the vacuum insulation panel. After the creation of the vacuum, the thermal insulation core material has a relatively low coefficient of thermal conductivity, and also has characteristics such as environment-protective, flame-resistant, and sound-insulating. The thermal insulation core material is widely used in fridge, freezer, refrigerator van, etc.

In the conventional process for manufacturing the thermal insulation core material, rigid polyurethane foam, Expanded PolyStyrene (EPS) boards and eXtruded PolyStyrene (XPS) boards are normally used as the thermal insulation core material. The rigid polyurethane foam has a coefficient of thermal conductivity of 25 mw/m·k, the EPS has a coefficient of thermal conductivity of 41 mw/m·k, and the XPS has a coefficient of thermal conductivity of 30 mw/m·k. The thermal conductivity of these materials is 10 times lower than traditional thermal insulation core materials, and these materials save about 40% to 60% in comparison with the traditional thermal insulation core materials. However, the coefficient of thermal conductivity of these materials is still high, and normally higher than 25 mw/m·k. Therefore, it is required to increase the thickness of thermal insulation panel so as to obtain the required thermal insulation property. In addition, the molecular movement in the rigid polyurethane foam, EPS and XPS is acute when heated, thus the thermal insulation property is reduced while temperature is increased. Furthermore, the rigid polyurethane foam, EPS and XPS are cancellous in structure, with low void fraction and relatively high close-cell ratio, thus the radiant heat from the environment is partially absorbed by the materials themselves such that the temperature of the materials is raised and the thermal conductivity is reduced.

A conventional process for manufacturing the thermal insulation core material is as follows: spraying water to damp the solid fiber cotton; compressing the fiber cotton at a temperature of 380° C. to obtain the thermal insulation core material.

Another conventional process for manufacturing the thermal insulation core material is as follows: spraying organic or inorganic adhesive on the solid fiber cotton to enable the solid fiber cotton to stick together to form a thermal insulation board.

A further conventional process for manufacturing the thermal insulation core material is as follows: melting rock wool at high temperature to form an inorganic fiber plate which is used as the thermal insulation core material.

It can be seen that the processes for manufacturing the thermal insulation core material in these conventional methods are realized by heating or compressing. The obtained plate-shaped thermal insulation core material has low density and many through holes, whereby the coefficient of thermal conductivity is high and the thermal insulation property is relatively low.

### BRIEF SUMMARY OF THE INVENTION

It is an object of the present invention to provide a process for manufacturing a thermal insulation core material which has improved thermal insulation property.

It is a further object of the present invention to provide a thermal insulation core material which has improved thermal insulation property.

It is still a further object of the present invention to provide a process for manufacturing a vacuum insulation panel which has better thermal insulation property.

According to one aspect of the present invention, a process for manufacturing a thermal insulation core material comprises:

A) stirring and dispersing a mixture of glass fiber cotton and water to obtain a slurry;

B) adding water and dilute sulfuric acid into the slurry to obtain a concentration of 0.1% and a pH value in a range of 2.5-3.0;

C) removing residue from the slurry to obtain a qualified slurry, the residue comprising unmelted glass fibers;

D) transporting the qualified slurry from a high-level tank to a head box, then controlling the qualified slurry to flow onto a forming mesh, where the qualified slurry is dehydrated to obtain a plate-shaped core material;

E) transporting the plate-shaped core material into a vacuum box for compression and dehydration; and

F) drying the plate-shaped core material.

According to a further aspect, the present invention provides a thermal insulation core material manufactured according to the above process.

According to a further aspect of the present invention, a process for manufacturing a vacuum insulation panel comprises:

placing a getter on the thermal insulation core material obtained from above process;

wrapping the thermal insulation core material and the getter by using an aluminum foil;

pumping the thermal insulation core material into a vacuum state; and

sealing the periphery of the aluminum foil around the thermal insulation core material to form a sealing cover protruded from the periphery of the thermal insulation core material.

According to a still further aspect, the present invention provides a vacuum insulation panel manufactured according to the process as described above.

It can be seen that, in the process for manufacturing the thermal insulation core material, water is mixed with the glass fiber cotton, and stirred evenly to enable the glass fiber cotton to be dispersed evenly in the slurry. Then residue is removed from the slurry to obtain the qualified slurry with relative high purity which is then transported onto the forming mesh, and dehydrated to obtain the plate-shaped core material (primary formed thermal-insulation core material). The plate-shaped core material is transported into the vacuum box for compression. Thus a compacter thermal insulation core material with smaller pores is obtained, and the thermal insulation capability is greatly improved.

When the thermal insulation core material is used in fridge, for example, a thinner thermal insulation core material with better insulation result can be thus realized to reduce the sidewall thickness of the fridge and reduce energy consumption in comparison conventional materials.

### BRIEF DESCRIPTION OF THE SEVERAL VIEWS OF THE DRAWING

For a more complete understanding of the present invention, and for further advantages thereof, reference is now made to the following description taken in conjunction with the accompanying drawings in which:

FIG. 1 is a schematic flowchart of a process for manufacturing a thermal insulation core material according to one embodiment of the present invention;

FIG. 2 is a diagram for a process of manufacturing a thermal insulation core material according to one embodiment of the present invention;

FIG. 3 is a schematic structural view of a drying device for a vacuum insulation panel according to one embodiment of the present invention;

FIG. 4 is a schematic structural view of a vacuum insulation panel according to one embodiment of the present invention; and

FIG. 5 is a schematic sectional view of the vacuum insulation panel in FIG. 4.

### DETAILED DESCRIPTION OF THE INVENTION

The following discussion is presented to enable a person skilled in the art to make and use the invention. Various modifications will be readily apparent to those skilled in the art, and the general principles described herein may be applied to embodiments and applications other than those detailed below without departing from the spirit and scope of the present invention as defined herein. The present invention is not intended to be limited to the embodiments shown, but is to be accorded the widest scope consistent with the principles and features disclosed herein.

Many aspects of the invention can be better understood in the following embodiments with reference to the accompanying drawings.

### Embodiment 1

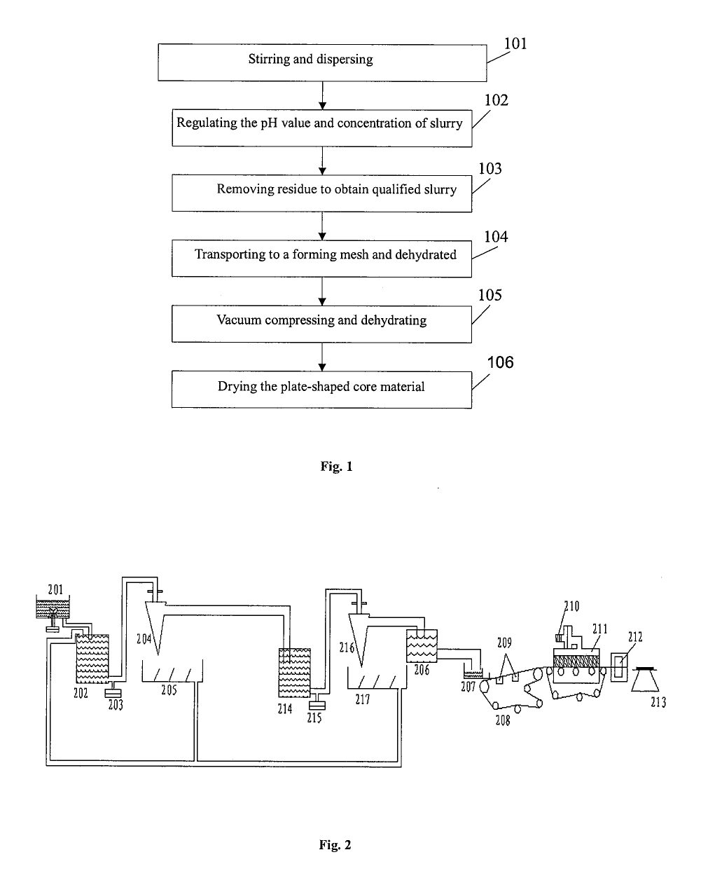

As illustrated in FIG. 1, a process for manufacturing a thermal insulation core material comprises the following steps:

Step 101: Stirring and Dispersing

Glass fiber cotton is stirred and dispersed in water to obtain a slurry.

In this embodiment, the glass fiber cotton comprises ingredients of 27-37 wt % of glass fiber cotton with a diameter of 2-3 micron, 15-18 wt % of glass fiber cotton with a diameter of 3-4 micron, 35-41 wt % of glass fiber cotton with a diameter of 4-5 micron, and 5-30 wt % of glass fiber cotton with a diameter of 6-8 micron.

It has been proved by experiment that a compacter thermal insulation core material with fewer pores can be obtained, and the thermal insulation capability is greatly improved while the manufacturing cost is maintained in a suitable level.

Step 102: Adjusting pH Value and Concentration of the Slurry

Water is added into the slurry to obtain a concentration of 0.1% (percentage by weight), and dilute sulfuric acid is added into the slurry to obtain a pH value in a range of 2.5-3.0.

If the pH value is too high, i.e. acidity is too low, then the glass fiber cotton in the slurry will be excessively dispersed such that the density of the thermal insulation core material obtained is too low, and thus the insulation property is affected. If the pH value is too low, i.e. acidity is too high, the glass fiber cotton exposed to the air tends to become pulverized, and the lifetime of the thermal insulation core material will be reduced. In the process of this embodiment, the pH value is controlled within a range of 2.5-3.0, and glass fiber cotton is properly dispersed in the slurry without the occurring of pulverization, and the thermal insulation core material obtained has a high density and is durable.

Step 103: Removing Residue to Obtain a Qualified Slurry

Residue is removed from the slurry to obtain a qualified slurry, wherein the residue includes unmelted glass fibers.

In this embodiment, the residue may be removed by depositing, or by using a residue remover, or by a method of combination thereof.

Step 104: Transporting to a Forming Mesh and Dehydrating

The qualified slurry is transported from a high-level tank to a head box through which the qualified slurry flows onto a forming mesh, where the qualified slurry is dehydrated under the action of gravity to obtain a plate-shaped core material.

Step 105: Vacuum Compressing and Dehydrating

The plate-shaped core material is transported into a vacuum box in order to be compressed and dehydrated.

After the qualified slurry is dehydrated and formed on the forming mesh to obtain the plate-shaped core material, the plate-shaped insulation core material is transported into the vacuum box to be compressed and further dehydrated to obtain a plate-shaped insulation core material with a specific intensity. In this embodiment, water content in the plate-shaped insulation core material is lower than 80% after being further dehydrated in the vacuum box.

Compared with conventional dry vacuum compression methods, the process of this embodiment in which the insulation core material is compressed and further dehydrated in the vacuum box reduces the size and quantity of the pores in the thermal insulation core material, and thus the thermal insulation property is greatly improved.

Step 106: Drying the Plate-Shaped Insulation Core Material

The plate-shaped core material obtained in the step 105 is dried in a drying chamber to obtain a dry thermal-insulation core material.

Different types of thermal insulation core materials have different coefficient of thermal conductivity. The thermal physical property will also be different if ingredients of the thermal insulation core materials are different. Furthermore, for thermal insulation core materials consisting of same ingredients, the final products may have great differences in thermal physical properties due to different interior structures and different manufacturing processes of the thermal insulation core materials.

A thermal insulation core material obtained by dry processing the glass fiber cotton has great difference in density in comparison with a thermal insulation core material obtained by wet-laid process. The pores in the thermal insulation core material obtained by dry processing are normally through-holes, while the pores in the thermal insulation core material obtained by wet-laid process are normally blind holes. With regard to heat conduction of a thermal insulation core material with certain porosity, the larger the pore size of the material, the higher the coefficient of thermal conductivity. Therefore, the through-hole has a higher coefficient of thermal conductivity than the blind hole. Moreover, the higher the ratio of the closed pores of a thermal insulation core material, the lower the coefficient of thermal conductivity of the material. When heat radiation is emitted onto an object, it may be reflected or pass through or be absorbed. If the energy is absorbed by the object, temperature of the object will be raised. Therefore, porous thermal insulation core material will reduce heat exchange during heat radiation.

The specific heat capacity of solid varies greatly as temperature changes. The specific heat capacity of a thermal insulation core material is reduced as temperature is reduced. In this embodiment, that is, in the wet-laid process, the thermal insulation core material formed from the glass fiber cotton is porous, and under the condition of vacuum heat insulation, the porosity of the material can reduce heat exchange during heat radiation to prevent its specific heat capacity from changing with temperature. Therefore, when designing, it is unnecessary to take into account of the specific heat capacity of the air, and only the specific heat capacity of the material itself should be considered. Compared with the rigid polyurethane foam, EPS and XPS, the material and process of this embodiment are more superior in designing and manufacturing.

In the process for manufacturing the thermal insulation core material of this embodiment, glass fiber cotton is mixed with water, and stirred evenly to enable the glass fiber cotton to be dispersed evenly in the slurry, then residue is removed from the slurry to obtain the qualified slurry with relative high purity. The qualified slurry is then transported onto the forming mesh and dehydrated to obtain the plate-shaped core material (primary formed thermal-insulation core material), and the plate-shaped core material is transported into the vacuum box for compression. As a result, a compacter thermal insulation core material with smaller pores is obtained, and the thermal insulation capability is greatly improved.

When the thermal insulation core material is used in fridge, for example, a thinner thermal insulation core material with better insulation result can be thus realized to reduce the sidewall thickness of the fridge and to reduce energy consumption in comparison with conventional materials.

### Embodiment 2

Referring to FIG. 2, an embodiment of a process for manufacturing the thermal insulation core material in Embodiment 1 is provided. In this embodiment, the glass fiber cotton comprises 27-37 wt % of glass fiber cotton with a diameter of 2-3 micron, 15-18 wt % of glass fiber cotton with a diameter of 3-4 micron, 35-41 wt % of glass fiber cotton with a diameter of 4-5 micron, and 5-30 wt % of glass fiber cotton with a diameter of 6-8 micron.

Referring to FIG. 2, glass fiber cotton and 1.5 m³ of water are added into a hydropulper 201, such that the concentration of the slurry is in a range of 2-3.5%. Dilute sulfuric acid with concentration of 15% is added into the glass fiber cotton and water slurry to obtain a pH value in a range of 2.5-3.0, preferably 2.8.

The glass fiber cotton and water are stirred in the hydropulper 201 at a stirring speed of 900-1000 r/min, preferably 980 r/min, for 20 to 30 minutes.

The slurry is stored in a storage tank 202, and water (or water recycled during the process) is added to dilute the slurry until the level line 12 m³ of the storage tank is reached. That is, the concentration of the slurry is 0.1%. Dilute sulfuric acid with concentration of 5% is added until the pH value of the slurry is 2.8. Then the slurry in the storage tank 202 is stirred evenly and pumped into a first residue remover 204 by a pump 203. The qualified slurry from the first residue remover 204 is transported to a leading tank 214, while the residue slurry removed by the first residue remover 204 is deposited into a first settling tank 205, where residue from the residue slurry may be further removed to obtain a qualified slurry, which is transported to the storage tank 202.

The slurry in the leading tank 214 is pumped into a second residue remover 216 by a pump 215 to remove unmelted glass fibers. The residue slurry removed by the second residue remover 216 flows through a second settling tank 217 to further remove residue to obtain a qualified slurry, which is then transported to the storage tank 202 to mix with the slurry stored in the storage tank 202.

The qualified slurry from the second residue remover 216 enters into a high-level tank 206 and then into a head box 207. The qualified slurry in the head box 207 is dispersed onto a forming mesh by the dispersing device of the head box 207, where a plate-shaped core material is formed after dehydration under action of gravity.

The plate-shaped core material is further dehydrated by vacuum boxes 209 to form a wet plate-shaped core material with a certain tensile strength, and the water content for such wet core material may be 80%. The wet plate-shaped core material is placed into a drying chamber 211, the heat of which is supplied by a drying device 210. The dried plate-shaped core material may have a water content lower than 0.7%. The dried plate-shaped core material may be sectioned in a sectioning device 212 to obtain final thermal insulation core materials which are placed on an operating table 213 for inspection. The qualified product after inspection may then packaged.

Conventionally, a drying device mainly utilizes natural gas burning in a U-shaped heat exchanging pipe to heat air passing through the outer wall of the heated U-shaped heat exchanging pipe. The heated air then flows into a drying chamber to realize the drying. Therefore, the heating air is heated indirectly, and the air carries small amount of the heat since the U-shaped pipe is very long, and a considerable amount of heat is discharged to the air by the exhausted gas after combustion of the natural gas. Moreover, the U-shaped pipe tends to be broken for being exposed to high temperature for a long time. Furthermore, response to a temperature control is slow, and it is not possible to reach a set temperature in a short time.

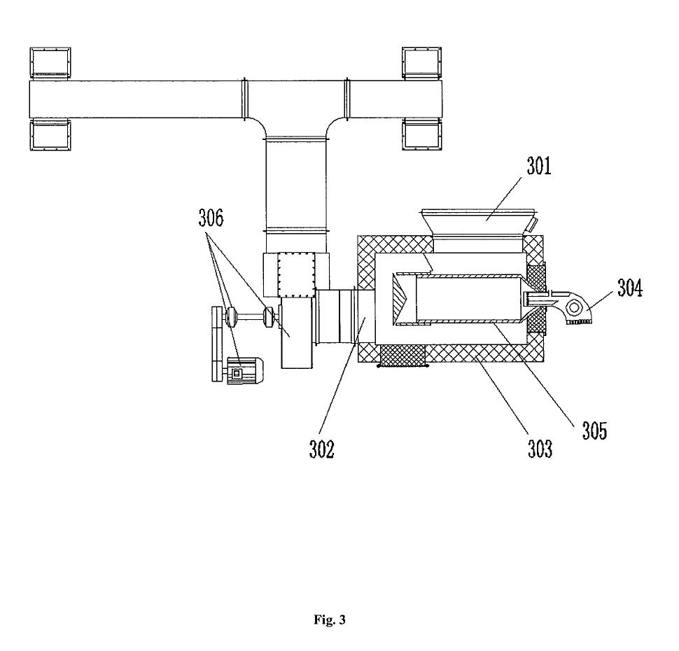

An embodiment of a drying device is illustrated FIG. 3 according to the present invention. The drying device includes an airflow heating chamber 303 having a cycle air inlet 301 and a cycle air outlet 302, a combustion device 304, and a frequency conversion fan 306 in communication with the air inlet 301 and the air outlet 302. A combustion chamber 305 having a gas inlet and a gas outlet is provided in the airflow heating chamber 303. The gas inlet of the combustion chamber 305 is communicated with the gas outlet of the combustion device 304, and the gas outlet of the combustion chamber 305 is in communication with the airflow heating chamber 303. When drying is performed, natural gas is burned in the combustion chamber 305, and the frequency conversion fan 306 enables air to flow through the air inlet 301, the air outlet 302 and the combustion chamber 305 circularly. The air is heated by the combustion chamber 305 and enters into the heating chamber 303 to dry a plate-shaped core material.

Compared with conventional drying techniques, in the embodiment of the drying process of the present invention, air is heated directly, and heat generated by the combustion of natural gas is completely absorbed by the air, thus utilization ratio is improved and energy is saved.

Referring back to FIG. 2, depositing and cycling operations are used for recycling the qualified slurry in the residue, which further improves utilization ratio of raw materials.

### Embodiment 3

In this embodiment, the glass fiber cotton having formula 1 is used, which comprises 27 wt % of glass fiber cotton with a diameter of 2-3 micron, 15 wt % of glass fiber cotton with a diameter of 3-4 micron, 35 wt % of glass fiber cotton with a diameter of 4-5 micron, and 23 wt % of glass fiber cotton with a diameter of 6-8 micron.

Referring back to FIG. 2, glass fiber cotton having formula 1 is added into the hydropulper 201, and 1.5 m³ of water is added to obtain a slurry. Dilute sulfuric acid is added to the slurry to obtain a pH value of 2.8, in which glass fibers are dispersed substantially and without the occurring of pulverization and accumulation. To ensure the safety of manufacturing, the dilute sulfuric acid with concentration of 15% is preferred.

If the pH value is too high, i.e. acidity is too low, then the glass fiber cotton in the slurry will be excessively dispersed such that the density of the thermal insulation core material obtained is too low, and thus the insulation property is reduced. If the pH value is too low, the glass fiber cotton exposed to the air tends to become pulverized, and the lifetime of the thermal insulation core material will be reduced. The pH value of 2.8 is preferred.

The glass fibers tend to be fractured due to the frangibility of the glass fiber if the rotation speed of stirring of the hydropulper 201 is too high; and if the rotation speed is too slow, the processing time is long and the cost for manufacturing may be significantly increased. In this embodiment, the glass fibers are substantially dispersed without being fractured when the stirring speed is 980 r/min for 20 minutes.

After stirring, the dispersed slurry is stored in the storage tank 202, and water (or water recycled during the process) is added to dilute the slurry until the level line 12 m³ of the storage tank is reached. In the process of adding water to dilute the slurry, if the concentration of the slurry is too high, the fibers will not be dispersed evenly enough and the thermal insulation property is thus affected; and if the concentration of the slurry is too low, it is not good for mass production due to the low production capacity. The concentration of the slurry being 0.1% is preferred. While water is added to dilute the concentration of the slurry, dilute sulfuric acid with concentration of 5% is also added until the pH value of the slurry is 2.8. The slurry in the storage tank 202 is stirred evenly and then pumped into the first residue remover 204 by the pump 203. The qualified slurry from the first residue remover 204 is transported to the leading tank 214, and the residue slurry removed by the first residue remover 204 is deposited in the first settling tank 205 to further remove residue, so as to obtain a qualified slurry which is transported back to the storage tank 202. The residue is deposited at the bottom of the first settling tank 205.

The slurry in the leading tank 214 is pumped into the second residue remover 216 by the pump 215 to remove residue. The residue slurry removed by the second residue remover 216 flows through a second settling tank 217 to further remove residue, so as to obtain a qualified slurry which is then transported back to the storage tank 202. The residue is deposited at the bottom of the second settling tank 217.

The qualified slurry from the second residue remover 216 enters into the high-level tank 206 and then into the head box 207. The qualified slurry in the head box 207 is then dispersed onto the forming mesh by the dispersing device of the head box 207, and then a plate-shaped core material is formed after dehydration. The plate-shaped core material is further dehydrated by the vacuum boxes 209 to form a wet plate-shaped core material with a certain tensile strength, and the water content for such wet core material is 80%. The wet plate-shaped core material is then placed into the drying chamber 211, the heat of which is supplied by the drying device 210. The dried plate-shaped core material has water content lower than 0.7%. The dried plate-shaped core material is then sectioned in the sectioning device 212 to obtain the final thermal insulation core material which is placed on the operating table 213 for inspection to obtain a qualified product.

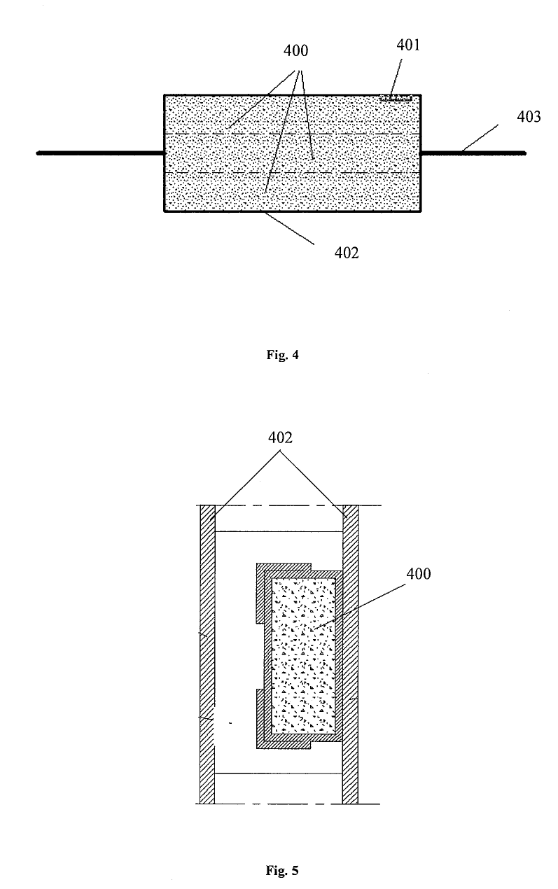

The qualified product can be then used for manufacturing vacuum insulation panels, as illustrated in FIGS. 4 and 5.

Referring to FIGS. 4 and 5, an embodiment of a vacuum insulation panel is illustrated. The vacuum insulation panel includes a thermal insulation core material 400 formed by the manufacturing process described above, and the thermal insulation core material is in vacuum state; a getter 401 on the outer side of the thermal insulation core material 400; an aluminum foil 402 wrapping around the thermal insulation core material 400 to keep the thermal insulation core material 400 in a vacuum state; and a sealing cover 403, formed by sealing the periphery of the aluminum foil around the thermal insulation core material 400 and protruding from the thermal insulation core material 400.

To better insulate the thermal insulation core material 400 from the environment, the sealing cover 403 is extended for a long distance from the thermal insulation core material 400, so that the thermal insulation core material 400 is better sealed in a vacuum state.

Furthermore, the getter 401 can remove the gas permeating through the sealing cover 403. Thus, the vacuum state of the thermal insulation core material 400 is guaranteed. The getter 401 may contain calcium oxide, zeolite, etc.

Table 1 is the test result of the coefficient of thermal conductivity of the vacuum insulation panel in this embodiment

TABLE 1

| Sample | 1 | 2 | 3 | 4 | 5 | 6 | 7 | 8 |
|---|---|---|---|---|---|---|---|---|
| Coefficient | 2.73 | 2.69 | 2.74 | 2.72 | 2.73 | 2.68 | 2.72 | 2.70 |
| of thermal | | | | | | | | |
| conductivity | | | | | | | | |
| (mw/m · k) | | | | | | | | |

### Embodiment 4

In this embodiment, the glass fiber cotton with formula 2 is used, which comprises 27 wt % of glass fiber cotton with a diameter of 2-3 micron; 8 wt % of glass fiber cotton with a diameter of 3-4 micron; 35 wt % of glass fiber cotton with a diameter of 4-5 micron; and 30 wt % of glass fiber cotton with a diameter of 6-8 micron.

The glass fiber cotton in formula 2 is added into the hydropulper 201, and processed according to the process as described in the Embodiment 3 to obtain the thermal insulation core material.

After the qualified thermal insulation core material is obtained, a getter is placed on the outer side of the thermal insulation core material. Then the thermal insulation core material and the getter are wrapped by an aluminum foil; pumped into a vacuum state. The periphery of the aluminum foil around the thermal insulation core material is sealed to form a sealing cover, which is protruded from the thermal insulation core material, and the vacuum insulation panel is obtained, as illustrated in FIGS. 4 and 5.

In this embodiment, the vacuum insulation panel includes the thermal insulation core material 400 formed by the process as described above and in a vacuum state; the getter 401 on the outer side of the thermal insulation core material 400; an aluminum foil 402 wrapping around the thermal insulation core material 400 to keep the thermal insulation core material 400 in a vacuum state; a sealing cover 403 formed by sealing the periphery of the aluminum foil around the thermal insulation core material 400. The sealing cover 403 is protruded from the thermal insulation core material 400.

To better insulate the thermal insulation core material 400 from the environment, the sealing cover 403 is extended for a long distance from the thermal insulation core material 400, so that the thermal insulation core material 400 is better sealed in a vacuum state.

Furthermore, the getter 401 can remove the gas entering from the sealing cover 403. Thus, the vacuum state of the thermal insulation core material 400 is guaranteed. The getter 401 may contain calcium oxide, zeolite, etc.

Table 2 is the test result of the coefficient of thermal conductivity of the vacuum insulation panel in this embodiment

TABLE 2

| Sample | 1 | 2 | 3 | 4 | 5 | 6 | 7 | 8 |
|---|---|---|---|---|---|---|---|---|
| Coefficient | 2.71 | 2.75 | 2.72 | 2.80 | 2.73 | 2.72 | 2.74 | 2.73 |
| of thermal | | | | | | | | |
| conductivity | | | | | | | | |
| (mw/m · k) | | | | | | | | |

### Embodiment 5

In this embodiment, the glass fiber cotton having a formula 3 is used, which comprises 30 wt % of glass fiber cotton with a diameter of 2-3 micron; 17 wt % of glass fiber cotton with a diameter of 3-4 micron; 37 wt % of glass fiber cotton with a diameter of 4-5 micron; and 17 wt % of glass fiber cotton with a diameter of 6-8 micron.

The glass fiber cotton with the formula 3 is added into the hydropulper 201, and processed according to the process as described in the Embodiment 3 to obtain the thermal insulation core material.

The qualified thermal insulation core material can then be used for manufacturing vacuum insulation panels, as illustrated in FIGS. 4 and 5.

In this embodiment, the vacuum insulation panel includes the thermal insulation core material 400 formed by the process as described above and in a vacuum state; the getter 401 on the outer side of the thermal insulation core material 400; the aluminum foil 402 wrapping around the thermal insulation core material 400 to keep the thermal insulation core material 400 in a vacuum state; the sealing cover 403 formed by sealing the periphery of the aluminum foil around the thermal insulation core material 400 and protruded from the thermal insulation core material 400.

To better insulate the thermal insulation core material 400 from the environment, the sealing cover 403 is extended for a long distance from the thermal insulation core material 400, so that the thermal insulation core material 400 is better sealed in a vacuum state.

Furthermore, the getter 401 can remove the gas permeating from the sealing cover 403. Thus, the vacuum state of the thermal insulation core material 400 is guaranteed. The getter 401 may contain calcium oxide, zeolite, etc.

Table 3 is the test result of the coefficient of thermal conductivity of the vacuum insulation panel in this embodiment

TABLE 3

| Sample | 1 | 2 | 3 | 4 | 5 | 6 | 7 | 8 |
|---|---|---|---|---|---|---|---|---|
| Coefficient | 2.51 | 2.53 | 2.48 | 2.49 | 2.49 | 2.50 | 2.48 | 2.51 |
| of thermal | | | | | | | | |
| conductivity | | | | | | | | |
| (mw/m · k) | | | | | | | | |

### Embodiment 6

In this embodiment, the glass fiber cotton having a formula 4 is used, which comprises 7 wt % of glass fiber cotton with a diameter of 2-3 micron; 5 wt % of glass fiber cotton with a diameter of 3-4 micron; 41 wt % of glass fiber cotton with a diameter of 4-5 micron; and 5 wt % of glass fiber cotton with a diameter of 6-8 micron.

The glass fiber cotton in formula 4 is added into the hydropulper 201, and processed according to the process as described in the Embodiment 3 to obtain the thermal insulation core material.

The qualified thermal insulation core material can then be used for manufacturing the vacuum insulation panel, as illustrated in FIGS. 4 and 5.

In this embodiment, the vacuum insulation panel includes the thermal insulation core material 400 formed by the process as described above and in a vacuum state; the getter 401 on the outer side of the thermal insulation core material 400; the aluminum foil 402 wrapping around the thermal insulation core material 400 to keep the thermal insulation core material 400 in a vacuum state; the sealing cover 403 formed by sealing the periphery of the aluminum foil around the thermal insulation core material 400 and protruded from the thermal insulation core material 400.

To better insulate the thermal insulation core material 400 from the environment, the sealing cover 403 is extended for a long distance from the thermal insulation core material 400, so that the thermal insulation core material 400 is better sealed in a vacuum state.

Furthermore, the getter 401 can remove the gas permeating from the sealing cover 403. Thus, the vacuum state of the thermal insulation core material 400 is guaranteed. The getter 401 may contain calcium oxide, zeolite, etc.

Table 4 is the test result of the coefficient of thermal conductivity of the vacuum insulation panel in this embodiment

TABLE 4

| Sample | 1 | 2 | 3 | 4 | 5 | 6 | 7 | 8 |
|---|---|---|---|---|---|---|---|---|
| Coefficient | 2.98 | 2.93 | 2.94 | 2.94 | 2.96 | 2.97 | 2.94 | 2.96 |
| of thermal | | | | | | | | |
| conductivity | | | | | | | | |
| (mw/m · k) | | | | | | | | |

Table 5 shows the comparison of the coefficient of thermal conductivity of the thermal insulation core materials obtained in the Embodiments, 3, 4, 5, and 6.

TABLE 5

| Sample | 1 | 2 | 3 | 4 | 5 | 6 | 7 | 8 |
|---|---|---|---|---|---|---|---|---|
| Formula 1 | 2.73 | 2.69 | 2.74 | 2.72 | 2.73 | 2.68 | 2.72 | 2.70 |
| Formula 2 | 2.71 | 2.75 | 2.72 | 2.80 | 2.73 | 2.72 | 2.74 | 2.73 |
| Formula 3 | 2.51 | 2.53 | 2.48 | 2.49 | 2.49 | 2.50 | 2.48 | 2.51 |
| Formula 4 | 2.98 | 2.93 | 2.94 | 2.94 | 2.96 | 2.97 | 2.94 | 2.96 |

It can be seen from the table 5 that in the embodiments 3 to 6, the thermal insulation core material having formula 3 has the lowest coefficient of thermal conductivity.

Table 6 shows the comparison of thermal conductivity of the vacuum insulation panel obtained in Embodiment 5 by using the formula 3 and vacuum insulation panels obtained from conventional materials utilizing dry compressing method.

TABLE 6

| Sample | 1 | 2 | 3 | 4 | 5 | 6 | 7 | 8 |
|---|---|---|---|---|---|---|---|---|
| Formula 3- | 2.51 | 2.53 | 2.48 | 2.49 | 2.49 | 2.50 | 2.48 | 2.51 |
| the process | | | | | | | | |
| of this | | | | | | | | |
| embodiment | | | | | | | | |
| polyurethane | 23.2 | 23.1 | 24.0 | 23.4 | 24.1 | 23.4 | 23.3 | 23.6 |
| foam - foaming | | | | | | | | |
| method | | | | | | | | |
| EPS- foaming | 39.4 | 39.8 | 38.8 | 39.4 | 38.9 | 39.1 | 38.6 | 39.4 |
| method | | | | | | | | |
| XPS- | 30.5 | 29.9 | 30.1 | 29.5 | 29.7 | 29.7 | 29.3 | 30.3 |
| extrusion | | | | | | | | |
| method | | | | | | | | |
| Dry com- | 45.7 | 46.8 | 45.4 | 46.2 | 46.0 | 45.9 | 45.9 | 46.1 |
| pressing | | | | | | | | |
| method with | | | | | | | | |
| glass fiber | | | | | | | | |
| cotton | | | | | | | | |

It can be seen from table 5 and table 6 that the thermal conductivity of the vacuum insulation panel obtained by using the process of the embodiments in the present invention is about 10 times better than that obtained by conventional methods.

Furthermore, the materials used in the embodiments of the present invention belong to inorganic fiber materials which can be naturally weathered in the environment without causing pollution.

It should be emphasized that the above-described embodiments can be combined freely. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A process for manufacturing a thermal insulation core material, comprising:
A) stirring and dispersing a mixture of glass fiber cotton and water to obtain a slurry;
B) adding water and dilute sulfuric acid into the slurry to obtain a concentration of 0.1% and a pH value in a range of 2.5-3.0;
C) removing residue from the slurry to obtain a qualified slurry, the residue comprising unmelted glass fibers;
D) transporting the qualified slurry from a high-level tank to a head box, and controlling the qualified slurry to flow onto a forming mesh, on which the qualified slurry is dehydrated to obtain a plate-shaped core material;
E) transporting the plate-shaped core material into a vacuum box to compress and dehydrate the plate-shaped core material; and
F) drying the plate-shaped core material.

2. The process of claim 1, wherein the glass fiber cotton comprises 27-37 wt % of glass fiber cotton with a diameter of 2-3 micron, 15-18 wt % of glass fiber cotton with a diameter of 3-4 micron, 35-41 wt % of glass fiber cotton with a diameter of 4-5 micron, and 5-30 wt % of glass fiber cotton with a diameter of 6-8 micron.

3. The process of claim 1, wherein in the step B), water and dilute sulfuric acid are added into the slurry to obtain a concentration of 0.1% and a pH value of 2.8.

4. The process of claim 1, wherein the glass fiber cotton comprises 30 wt % of glass fiber cotton with a diameter of 2-3 micron, 16 wt % of glass fiber cotton with a diameter of 3-4 micron, 37 wt % of glass fiber cotton with a diameter of 4-5 micron, and 17 wt % of glass fiber cotton with a diameter of 6-8 micron.

5. The process of claim 1, wherein the glass fiber cotton comprises 27 wt % of glass fiber cotton with a diameter of 2-3 micron, 15 wt % of glass fiber cotton with a diameter of 3-4 micron, 35 wt % of glass fiber cotton with a diameter of 4-5 micron, and 23 wt % of glass fiber cotton with a diameter of 6-8 micron.

6. The process of claim 1, wherein the glass fiber cotton comprises 27 wt % of glass fiber cotton with a diameter of 2-3 micron, 8 wt % of glass fiber cotton with a diameter of 3-4 micron, 35 wt % of glass fiber cotton with a diameter of 4-5 micron, and 30 wt % of glass fiber cotton with a diameter of 6-8 micron.

7. The process of claim 1, wherein the glass fiber cotton comprises 37 wt % of glass fiber cotton with a diameter of 2-3 micron, 5 wt % of glass fiber cotton with a diameter of 3-4 micron, 41 wt % of glass fiber cotton with a diameter of 4-5 micron, and 5 wt % of glass fiber cotton with a diameter of 6-8 micron.

8. The process of claim 1, wherein the step C) further comprises:
1) removing residue from the slurry to generate a first residue slurry and a first qualified slurry;
2) removing residue from the first qualified slurry to generate qualified slurry; and
3) repeating step 1) to remove residue from the first residue slurry to generate qualified slurry.

9. The process of claim 8, wherein the step of removing residue from the first qualified slurry to generate qualified slurry comprises:
1) removing residue from the first qualified slurry to generate a second residue slurry and a second qualified slurry; and
2) repeating step 1) to remove residue from the second residue slurry to generate qualified slurry.

10. The process of claim 1, wherein the plate-shaped core material is dried by heated airflow in a heating chamber, the airflow being heated in a combustion chamber and flowing into the heating chamber.

11. The process of claim 10, wherein the plate-shaped core material is dried by the heated airflow in the heating chamber until water content in the plate-shaped core material is less than 0.7 wt %.

12. The process of claim 1, wherein step A) further comprises:
mixing the glass fiber cotton with the water to obtain a slurry of concentration 2-3.5%;
adding dilute sulfuric acid into the slurry to obtain a pH value in a range of 2.5-3.0; and
stirring and dispersing the slurry.

13. The process of claim 12, wherein the step of adding dilute sulfuric acid into the slurry to obtain a pH value in a range of 2.5-3.0 comprises adding dilute sulfuric acid with concentration of 15% into the slurry to obtain a pH value of 2.8.

14. The process of claim 12, wherein the slurry is stirred at a speed of 900-1000 r/min for 20 to 30 minutes.

15. A thermal insulation core material manufactured according to the process of claim 1.

16. A process for manufacturing a vacuum insulation panel, comprising:
placing a getter on a thermal insulation core material obtained according to the process of claim 1;
wrapping the thermal insulation core material and the getter by using an aluminum foil;
pumping the thermal insulation core material into a vacuum state; and
sealing the periphery of the aluminum foil around the thermal insulation core material to form a sealing cover protruded from the periphery of the thermal insulation core material.

17. The process of claim 16, wherein the getter contains calcium oxide or zeolite.

18. A vacuum insulation panel manufactured according to the process of claim 16 or 17.

19. A vacuum insulation panel manufactured according to the process of claim 17.
